(19) United States
(12) Patent Application Publication
(10) Pub. No.: US 2016/0219120 A1
(43) Pub. Date: Jul. 28, 2016

(54) METHODS FOR PROVIDING A STAGING AREA FOR OBJECTS PRIOR TO ERASURE CODING AND DEVICES THEREOF

(71) Applicant: NetApp, Inc., Sunnyvale, CA (US)

(72) Inventors: Emalayan Vairavanathan, Vancouver (CA); Dheeraj Sangamkar, Vancouver (CA); Ajay Bakre, Bangalore (IN); Vladimir Avram, Vancouver (CA); Viswanath C, Bangalore (IN)

(21) Appl. No.: 14/603,411

(22) Filed: Jan. 23, 2015

(51) Int. Cl. H04L 29/08; H04L 29/06

(52) U.S. Cl. CPC H04L 67/2842; H04L 67/42; H04L 67/1097

(57) ABSTRACT

A method, non-transitory computer readable medium, and device that provides staging area for an object prior to erasure coding includes receiving an object from a client computing device to ingest to a plurality of storage servers. The received object is cached in one or more memory locations. A notification is provided to the client computing device indicating successful receipt of the object. The received object is distributed across the plurality of storage servers upon providing the notification to the client computing device.

### FIELD

This technology generally relates to data storage management and, more particularly, methods for staging area for objects prior to erasure coding and devices thereof.

### BACKGROUND

Geographically distributed storage systems are used in the current technologies to store files or data by the clients due to the high end-to-end performance and reliability. To use these geographically distributed storage systems, existing technologies use erasure coding techniques. For purpose of further illustration of erasure coding, the data is divided into numerous data fragments and parity fragments are created. The original data can be recovered from a subset of the data fragments and the parity fragments.

However, while performing the erasure coding and distributing the data in parallel while the data is being received, prior technologies offers very low ingestion performance By way of example, low ingestion performance means the amount of data ingested by the client device to the geographically distributed storage systems is restricted by the storage management device which is required to accept the ingested data and perform erasure coding in parallel. Accordingly, with prior technologies the client device only gets a confirmation indicating that the data has been successfully received only when the erasure coding has been completed and the data has been distributed across geographically distributed storage systems. As a result, with these prior technologies the client device experiences unnecessary delay as the data is ingested into the geographically distributed storage systems.

### SUMMARY

A method for providing a staging area for an object prior to erasure coding includes receiving by a storage management computing device an object from a client computing device to ingest to a plurality of storage servers. The received object is cached by the storage management computing device in one or more memory locations. A notification is provided to the client computing device indicating successful receipt of the object by the storage management computing device. The received object is distributed by the storage management computing device across the plurality of storage servers upon providing the notification to the client computing device.

A non-transitory computer readable medium having stored thereon instructions for providing a staging area for an object prior to erasure coding comprising executable code which when executed by a processor, causes the processor to perform steps includes receiving an object from a client computing device to ingest to a plurality of storage servers. The received object is cached in one or more memory locations. A notification is provided to the client computing device indicating successful receipt of the object. The received object is distributed across the plurality of storage servers upon providing the notification to the client computing device.

A storage management computing device includes a processor and a memory coupled to the processor which is configured to be capable of executing programmed instructions comprising and stored in the memory to receive an object from a client computing device to ingest to a plurality of storage servers. The received object is cached in one or more memory locations. A notification is provided to the client computing device indicating successful receipt of the object. The received object is distributed across the plurality of storage servers upon providing the notification to the client computing device.

This technology provides a number of advantages including providing methods, non-transitory computer readable medium and devices for providing a staging area for an object prior to erasure coding. This technology provides high ingest rates by offloading erasure coding from the ingest path, i.e., erasure coding is performed once the received object is stored and a notification is provided to the client device, which improves functioning of the computing devices.

### BRIEF DESCRIPTION OF THE DRAWINGS

FIG. 1 is a block diagram of an environment with an exemplary storage management computing device;

FIG. 2 is a block diagram of the exemplary storage management computing device shown in FIG. 1; and

FIG. 3 is a flow chart of an example of a method for a staging area for objects prior to erasure coding.

### DETAILED DESCRIPTION

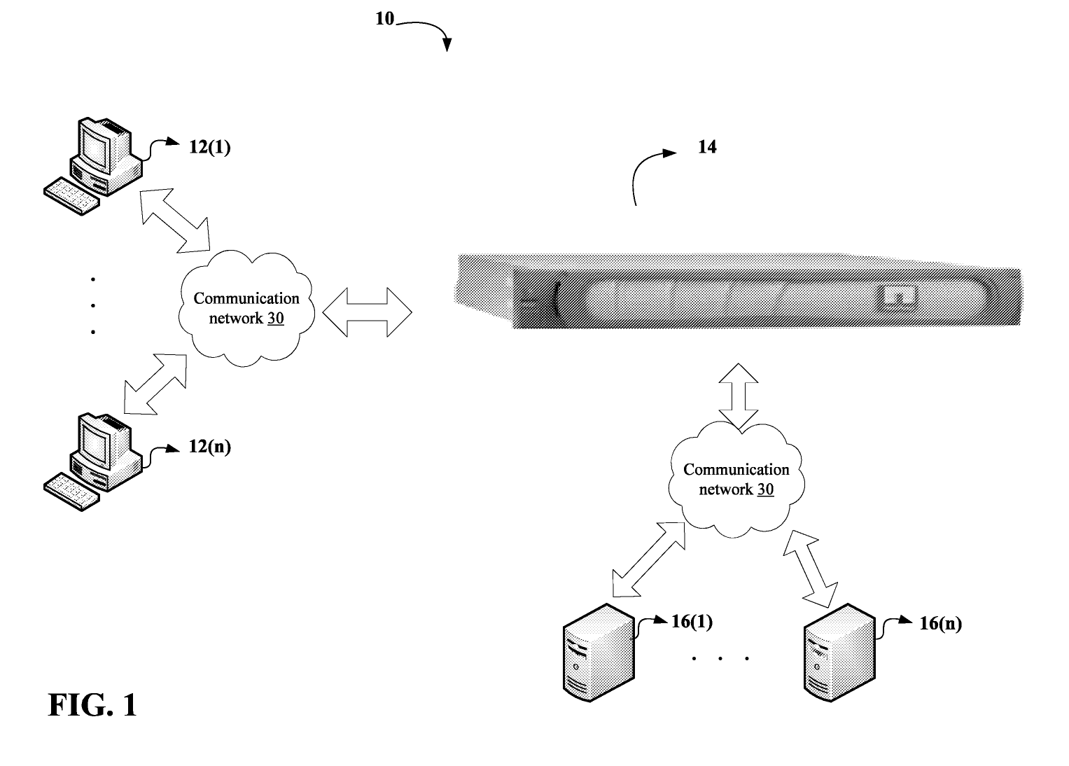

An environment 10 with a plurality of client computing devices 12(1)-12(n), an exemplary storage management computing device 14, a plurality of storage servers 16(1)-16(n) is illustrated in FIG. 1. In this particular example, the environment 10 in FIG. 1 includes the plurality of client computing devices 12(1)-12(n), the storage management computing device 14 and a plurality of storage servers 16(1)-16(n) coupled via one or more communication networks 30, although the environment could include other types and numbers of systems, devices, components, and/or other elements. In this example, the method for providing a staging area for objects prior to erasure coding is executed by the storage management computing device 14 although the approaches illustrated and described herein could be executed by other systems and devices. The environment 10 may include other types and numbers of other network elements and devices, as is generally known in the art and will not be illustrated or described herein. This technology provides a number of advantages including providing methods, non-transitory computer readable medium and devices for providing a staging area for objects prior to erasure coding.

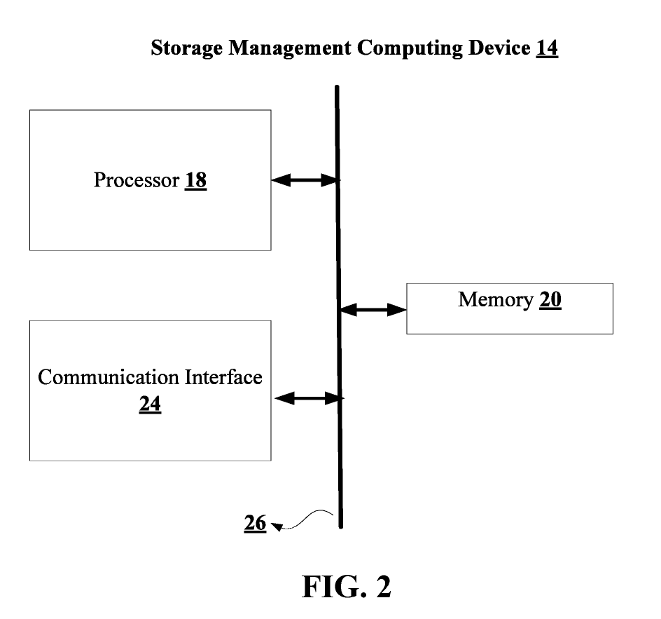

Referring to FIG. 2, in this example the storage management computing device 14 includes a processor 18, a memory 20, and a communication interface 24 which are coupled together by a bus 26, although the storage management computing device 14 may include other types and numbers of elements in other configurations.

The processor 18 of the storage management computing device 14 may execute one or more programmed instructions stored in the memory 20 for staging area for objects prior to erasure coding as illustrated and described in the examples herein, although other types and numbers of functions and/or other operation can be performed. The processor 18 of the storage management computing device 14 may include one or more central processing units (“CPUs”) or general purpose processors with one or more processing cores, such as AMD® processor(s), although other types of processor(s) could be used (e.g., Intel®).

The memory 20 of the storage management computing device 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication interface 24 of the storage management computing device 14 operatively couples and communicates with the plurality of client computing devices 12(1)-12(n) and the plurality of storage servers 16(1)-16(n), which are all coupled together by the communication network 30, although other types and numbers of communication networks or systems with other types and numbers of connections and configurations to other devices and elements. By way of example only, the communication network 30 can use TCP/IP over Ethernet and industry-standard protocols, including NFS, CIFS, SOAP, XML, LDAP, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like. In this example, the bus 26 is a universal serial bus, although other bus types and links may be used, such as PCI-Express or hyper-transport bus.

Each of the plurality of client computing devices 12(1)-12(n) includes a central processing unit (CPU) or processor, a memory, an interface device, and an I/O system, which are coupled together by a bus or other link, although other numbers and types of network devices could be used. The plurality of client computing devices 12(1)-12(n) communicates with the storage management computing device 14 to storing files and data in the plurality of storage servers 16(1)-16(n), although the client computing devices 12(1)-12(n) can interact with the storage management computing device 14 for other purposes. By way of example, the plurality of client computing devices 12(1)-12(n) may run interface application(s) that may provide an interface to make requests to access, modify, delete, edit, read or write data within storage management computing device 14 or the plurality of storage servers 16(1)-16(n) via the communication network 30.

Each of the plurality of storage servers 16(1)-16(n) includes a central processing unit (CPU) or processor, a memory, an interface device, and an I/O system, which are coupled together by a bus or other link, although other numbers and types of network devices could be used. Each of the plurality of storage servers 16(1)-16(n) assist with storing of files and data from the plurality of client computing devices 12(1)-12(n) or the storage management computing device 14, although the plurality of storage servers 16(1)-16(n) can assist with other types of operations. In this example, each of the plurality of storage servers 16(1)-16(n) can be spread across different geographical locations. In another example, all of the plurality of storage servers 16(1)-16(n) can be present in one geographical location. Various network processing applications, such as CIFS applications, NFS applications, HTTP Web Data storage device applications, and/or FTP applications, may be operating on the plurality of storage servers 16(1)-16(n) and transmitting data (e.g., files or web pages) in response to requests from the storage management computing device 14 and the plurality of client computing devices 12(1)-12(n). It is to be understood that the plurality of storage servers 16(1)-16(n) may be hardware or software or may represent a system with multiple external resource servers, which may include internal or external networks. In this example the plurality of storage servers 16(1)-16(n) may be any version of Microsoft® IIS servers or Apache® servers, although other types of servers may be used.

Although the exemplary network environment 10 includes the plurality of client computing devices 12(1)-12(n), the storage management computing device 14, and the plurality of storage servers 16(1)-16(n) described and illustrated herein, other types and numbers of systems, devices, components, and/or other elements in other topologies can be used. It is to be understood that the systems of the examples described herein are for exemplary purposes, as many variations of the specific hardware and software used to implement the examples are possible, as will be appreciated by those of ordinary skill in the art.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

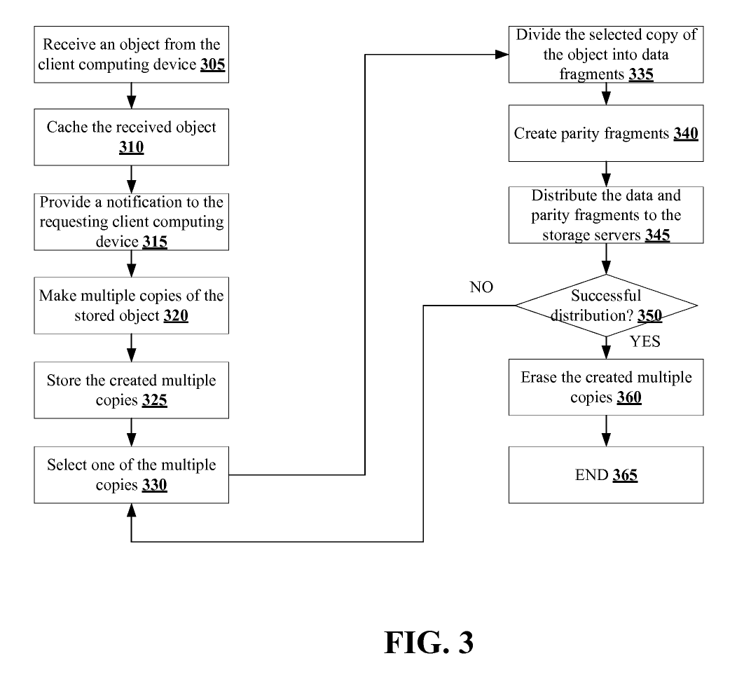

An example of a method for providing a staging area for objects prior to erasure coding will now be described herein with reference to FIGS. 1-3. In step 305, the storage management computing device 14 receives an object from one of the plurality of client computing devices 12(1)-12(n), although the storage management computing device 14 can receive other types and amounts of information from the plurality of client computing devices 12(1)-12(n). In this example, an object relates to a file, although objects can include other types and/or amounts of information.

In step 310, the storage management computing device 14 caches the received object in the memory 20, although the storage management computing device 14 can cache the received object at other memory locations including the plurality of storage servers 16(1)-16(n). Alternatively in another example, the storage management computing device 14 can split the received objects and store some parts in the memory 20 and the remaining parts of the object in one or more of the plurality of storage servers 16(1)-16(n). In this example, the location at which the received object is cached (either memory 20 or one or more of the plurality of storage servers 16(1)-16(n)) is termed as a staging area, although the staging area can include other memory locations at which the received object can be cached or stored. Additionally, the staging area can also be used to compose multiple small objects into a single object.

Next in step 315, the storage management computing device 14 provides a notification to the requesting one of the plurality of client computing devices 12(1)-12(n) indicating that the object has been received successfully.

In step 320, the storage management computing device 14 creates multiple copies of the stored object. In this example, the storage management computing device 14 creates the multiple copies of the stored object to protect the object from failures. Additionally, the multiple copies which are created are non-erasure copies of the object. As it would be appreciated by one of ordinary skill in the art, non-erasure copies relate to copies of an object prior to performing erasure coding.

In step 325, the storage management computing device 14 stores the created multiple copies of the stored object in the memory 20, although the storage management computing device 14 can store the created multiple copies in the plurality of storage servers 16(1)-16(n). As illustrated earlier, in this example, the plurality of storage servers 16(1)-16(n) are spread across different geographical locations.

In step 330, the storage management computing device 14 selects one of the multiple copies of the object. In this example, the storage management computing device 14 selects the first copy of the object cached in step 310 illustrated above, although the storage management computing device 14 can select any one of the multiple copies of the objected created in step 320.

In step 335, the storage management computing device 14 divides the selected one of the multiple copies of the object into multiple data fragments. In this example, the storage management computing device 14 uses Reed Solomon erasure coding technique, which is incorporated here by reference in its entirety, for diving the selected one of the multiple copies of the object, although the storage management computing device 14 can use other techniques to divide the selected copy of the object.

In step 340, the storage management computing device 14 creates multiple parity fragments for the divided data fragments. Again in this example, the storage management computing device uses Reed Solomon erasure coding technique, which is incorporated here by reference in its entirety, for creating parity fragments, although the storage management computing device can use other techniques to create the parity fragments. The technique illustrated in steps 335 and 340 is collectively termed as erasure coding in this example.

In step 345, the storage management computing device 14 distributes the data fragments and the parity fragments to the plurality of storage servers 16(1)-16(n). In this example, the storage management computing device 14 distributes the created data fragments and the parity fragments to the plurality of storage servers 16(1)-16(n) based on the performance, cost and reliability of the plurality of storage servers 16(1)-16(n), although the storage management computing device 14 can distribute based on other parameters.

Next in step 350, the storage management computing device 14 determines when all of the data fragments and the parity fragments have been successfully distributed across the plurality of storage servers 16(1)-16(n). In this example, when each of the data fragment and the parity fragment has been distributed to different plurality of storage servers 16(1)-16(n) (a data fragment and a parity fragment not distributed to the same storage server), the distribution is determined to be successful. Accordingly, when the storage management computing device 14 determines that the storage management computing device 14 has not been successfully distributed, then the No branch is taken back to step 330 where the storage management computing device 14 selects one of the multiple copies of the stored object to again repeat the steps of 335-345. However, when the storage management computing device 14 determines that the distribution of the data fragments and the parity fragments has been successfully completed, then the Yes branch is taken to step 360.

In step 360, the storage management computing device 14 erases or deletes the created multiple copies of the stored object and the exemplary method ends in step 365. Alternatively in another example, the storage management computing device 14 can also erase the cached object illustrated in step 310.

Accordingly, as illustrated and described with reference to the examples herein, this technology provides methods, non-transitory computer readable medium and devices that are able to efficiently provide a staging area for objects prior to erasure coding. By using the techniques illustrated above, the technology disclosed herein is able to provide high ingest rates by offloading erasure coding from the ingest path, i.e., erasure coding is performed once the received object is stored in the cache as opposed to performing erasure coding simultaneously while receiving objects. Additionally, the technology is also able to hide the network issues across data centers from an end user by providing a notification to the client device confirming the receipt of the object and then performing the erasure coding.

Additionally, when there is a request to access the received object from one of the plurality of client computing devices 12(1)-12(n), the storage management computing device 14 retrieves a subset of the data fragments using the parity fragments and then decodes the retrieved subset of the data fragments to form the received object. This objected formed using the retrieved subset of data fragments can also be cached using the technique illustrated in step 310 to support any subsequent requests for the object. By caching the constructed or formed object using the subset of data fragments, the technology disclosed herein is able to efficiently and rapid provide the requested object to the plurality of client computing devices 12(1)-12(n). Additionally, this technique also reduces the network, input/output and reconstruction overhead on the storage management computing device 14 thereby increasing the performance of the storage management computing device 14.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for providing a staging area for an object prior to erasure coding, the method comprising:
receiving, by a storage management computing device, an object from a client computing device to ingest to a plurality of storage servers;
caching, by the storage management computing device, the received object in one or more memory locations;
providing, by the storage management computing device, a notification to the client computing device indicating successful receipt of the object; and
distributing, by the storage management computing device, the received object across the plurality of storage servers upon providing the notification to the client computing device.

2. The method as set forth in claim 1 further comprising creating, by the storage management computing device, two or more copies of the received object prior to the distributing.

3. The method as set forth in claim 2 further comprising storing, by the storage management computing device, the created two or more copies of the received object.

4. The method as set forth in claim 3 further comprising determining, by the storage management computing device, when the received object has been successfully distributed across the plurality of storage servers.

5. The method as set forth in claim 4 further comprising deleting, by the storage management computing device, the stored two or more copies of the received object when the received object is determined to have been successfully distributed across the plurality of storage servers.

6. The method as set forth in claim 1 wherein the determining further comprises:
dividing, by the storage management computing device, the cached object into a plurality of data fragments;
creating, by the storage management computing device, a plurality of parity fragments from the divided plurality of data fragments; and
distributing, by the storage management computing device, the divided plurality of data fragments and the created plurality of parity fragments across the plurality of storage servers.

7. A non-transitory computer readable medium having stored thereon instructions for providing a staging area for an object prior to erasure coding comprising executable code which when executed by a processor, causes the processor to perform steps comprising:
receiving an object from a client computing device to ingest to a plurality of storage servers;
caching the received object in one or more memory locations;
providing a notification to the client computing device indicating successful receipt of the object; and
distributing the received object across the plurality of storage servers upon providing the notification to the client computing device.

8. The medium as set forth in claim 7 further comprising creating two or more copies of the received object prior to the distributing.

9. The medium as set forth in claim 8 further comprising storing the created two or more copies of the received object.

10. The medium as set forth in claim 9 further comprising determining when the received object has been successfully distributed across the plurality of storage servers.

11. The medium as set forth in claim 10 further comprising deleting the stored two or more copies of the received object when the received object is determined to have been successfully distributed across the plurality of storage servers.

12. The medium as set forth in claim 7 wherein the determining further comprises:
dividing the cached object into a plurality of data fragments;
creating a plurality of parity fragments from the divided plurality of data fragments; and
distributing the divided plurality of data fragments and the created plurality of parity fragments across the plurality of storage servers.

13. A storage management computing device comprising:
a processor;
a memory coupled to the processor which is configured to be capable of executing programmed instructions comprising and stored in the memory to:
receive an object from a client computing device to ingest to a plurality of storage servers;
cache the received object in one or more memory locations;
provide a notification to the client computing device indicating successful receipt of the object; and
distribute the received object across the plurality of storage servers upon providing the notification to the client computing device.

14. The device as set forth in claim 13, wherein the processor coupled to the memory is further configured to be capable of executing at least one additional programmed instruction comprising and stored in the memory to create two or more copies of the received object prior to the distributing.

15. The device as set forth in claim 14, wherein the processor coupled to the memory is further configured to be capable of executing at least one additional programmed instruction comprising and stored in the memory to store the created two or more copies of the received object.

16. The device as set forth in claim 15, wherein the processor coupled to the memory is further configured to be capable of executing at least one additional programmed instruction comprising and stored in the memory to determine when the received object has been successfully distributed across the plurality of storage servers.

17. The device as set forth in claim 16, wherein the processor coupled to the memory is further configured to be capable of executing at least one additional programmed instruction comprising and stored in the memory to delete the stored two or more copies of the received object when the received object is determined to have been successfully distributed across the plurality of storage servers.

18. The device as set forth in claim 13, wherein the processor coupled to the memory is further configured to be capable of executing the programmed instructions further comprising and stored in the memory to determine further comprises:
divide the cached object into a plurality of data fragments;
create a plurality of parity fragments from the divided plurality of data fragments; and
distribute the divided plurality of data fragments and the created plurality of parity fragments across the plurality of storage servers.
